(19) United States
(12) Patent Application Publication
(10) Pub. No.: US 2009/0253579 A1
(43) Pub. Date: Oct. 8, 2009

(54) Methods of Applying Ethylene Biosynthesis Inhibitor Compositions by Thermal Fogging

(76) Inventors: Daniel F. HEIMAN, Libertyville, IL (US); Benjamin A. BELKIND, Wilmette, IL (US); Gregory D. VENBURG, Deerfield, IL (US); Peter D. PETRACEK, Grayslake, IL (US); Carolina Andrea TORRES DEL CAMPO, Talca (CL); Abdullah MOSTAMANDI, Yakima, WA (US); Edmund T.K. HUANG, Naches, WA (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/417,028

(22) Filed: Apr. 2, 2009

Related U.S. Application Data
(60) Provisional application No. 61/042,071, filed on Apr. 3, 2008.

(51) Int. Cl. A01N 37/02

(52) U.S. Cl. 504/320

(57) ABSTRACT

The present invention generally relates to methods of thermal fogging ethylene synthesis inhibitor compositions for post-harvest treatment of crops. A preferred ethylene synthesis inhibitor is aminoethyoxyvinylglycine hydrochloride (AVG HCl). In a preferred embodiment, a method comprises producing a thermal fogging mist from said composition, wherein said thermal fogging mist contains particles of the ethylene synthesis inhibitor and applying an effective amount of said thermal fogging mist to said crops.

### FIELD OF THE INVENTION

The present invention generally relates to methods of applying ethylene synthesis inhibitor compositions by thermal fogging for post-harvest treatment of crops.

### BACKGROUND OF THE INVENTION

Plants produce ethylene by converting methionine through S-adenosylmethionine into 1-aminocyclopropane-1-carboxylic acid (ACC) which is then broken down into ethylene, HCN and carbon dioxide. The plant enzyme responsible for the production of ACC is ACC synthase. Ethylene, a gaseous phytohormone, is believed to be involved in the modulation of a number of plant biochemical pathways affecting such processes as abscission, senescence, flowering, fruit setting, fruit ripening, seed germination, sex expression, root growth, internode elongation, epinasty and geotropism.

The role of ethylene in the ripening of fruit has been recognized in the art for over 40 years. It is known that the rate of production of ethylene in maturing fruit increases while the fruit separates from its pedicel through the formation of a layer of cells with low adhesion known as the abscission layer. If the formation of this layer is completed before the fruit can be picked, the fruit falls to the ground, sustaining injury, which results in poorer quality. Thus, the prevention of preharvest fruit drop is of significant economic benefit to the grower. In addition, fruit typically has higher resistance to bruising and penetration injury before or immediately after harvest than after storage for a period of time. Fruit firmness is also a generally accepted measure of crispness and freshness. Typically at harvest, fruit has higher firmness than after storage. It is thought that the decrease in fruit firmness over time is, at least indirectly, related to the production of ethylene within the fruit.

Aminoethoxyvinylglycine (AVG) is a plant growth regulator which inhibits ethylene production. It acts by inhibiting the plant enzyme ACC synthase. AVG is described, for example, in U.S. Pat. No. 6,153,559.

There is a significant amount of literature addressing the effects of AVG on many fruit quality parameters, such as firmness, solubility, acidity, color development and other parameters that change as fruit ripens. The effectiveness of AVG in retaining fruit quality or delaying ripeness depends on the time and method of AVG application. Currently, AVG is commercially applied before harvest (i.e., “pre-harvest”).

The term “thermal fogging” (or thermofogging) refers to any technique by which active agents are applied to crops by entraining the active agent in a flow of heated air at controlled temperatures, concentrations and velocities to produce a mist. Various forms of thermal fogging techniques are known. For example, U.S. Pat. No. 6,723,364 describes some of these techniques. A thermal fogging device and a corresponding thermal fogging process are also described, for example, in French patent FR 84 10 372. Thermal fogging devices produce a thermal fogging mist from compositions containing active ingredients applied to fruits in accordance with the present invention.

Thermal fogging is suitable for delivery of various molecules and agents to harvested crops, crops being grown indoors and outdoors for maintenance of quality, prevention of disease, control of pests, etc. It is also suitable for delivery of molecules and agents to enclosed spaces and outdoor spaces for the control of pests and disease vectors.

Certain aspects of the current practiced thermal fogging technique limit the molecules and agents that can be successfully thermally fogged. Thermal fogging currently is suitable for molecules and agents that have high thermal stability given the high temperatures utilized in the thermal fogging process. Thermally sensitive molecules suffer unacceptable levels of degradation in the currently practiced thermal fogging technique. Furthermore, the molecules and agents to be thermally fogged must be compatible with solvent systems suitable for the thermal fogging process. Current thermal fogging solvent systems can only tolerate small amounts of water, yet polar charged molecules may require significant amounts of water. However, due to the above cited limitations, many potentially useful agrochemicals are poorly suited for efficient and effective delivery using current thermal fogging formulations and current thermal fogging equipment.

### SUMMARY OF THE INVENTION

The present invention is generally directed to a method of applying a composition comprising an ethylene synthesis inhibitor to crops by thermal fogging comprising the steps of producing a thermal fogging mist from said composition, wherein said thermal fogging mist contains particles of the ethylene synthesis inhibitor, and applying an effective amount of said thermal fogging mist to said crops.

Preferably, the ethylene synthesis inhibitor is aminoethoxyvinylglycine or a salt thereof; most preferably aminoethoxyvinylglycine hydrochloride (AVG HCl).

In one embodiment, the crop is a fruit. In a preferred embodiment, the fruit is an apple.

In another embodiment, the crop is a vegetable.

In a preferred embodiment, the methods of the present invention allow one to achieve residues of at least about 800 parts per billion (ppb) AVG HCl on the crops in a treatment chamber or storage room as measured immediately after application.

Preferably, the thermal fogging mist is produced by injecting the liquid treating composition into hot air projected at high velocity into the atomization/gas mixing unit of a thermal fogging device.

In a preferred embodiment, the temperature of the projected hot air is between about 180° C. and about 500° C.; most preferably about 300° C.

In another preferred embodiment, the velocity of the projected hot air is between about 50 m/s and about 300 m/s; most preferably about 250 m/s.

The exit temperature of said particles from the thermal fogging device is between about 100° C. and about 175° C., preferably between about 130 and about 150° C. The preferred exit temperature varies with the specific formulation used.

In the most preferred embodiment, the invention relates to a method of applying a composition comprising an ethylene synthesis inhibitor to crops by thermal fogging, wherein said method comprises the steps of producing a thermal fogging mist from said composition, wherein said thermal fogging mist contains particles of the ethylene synthesis inhibitor; applying an effective amount of said thermal fogging mist to said crops, wherein the thermal fogging mist is produced by injecting said composition into a thermal fogging device and projecting hot air into the device, wherein said hot air has a temperature of about 300° C. and a velocity of about 250 m/s, and wherein the exit temperature of said particles from the thermal fogging device is about 130-150° C.

### DETAILED DESCRIPTION OF THE INVENTION

The present invention is generally directed to a method of applying a composition comprising an ethylene synthesis inhibitor to crops by thermal fogging comprising the steps of producing a thermal fogging mist from said composition, wherein said thermal fogging mist contains particles of the ethylene synthesis inhibitor and applying an effective amount of said thermal fogging mist to said crops.

The term “crop(s)” as used herein refers to the edible parts of terrestrial plants. The term includes, but is not limited to, foods. Foods include, but are not limited to, vegetables, grains and fruits. Vegetables include, but are not limited to, beans, corn, tomatoes, broccoli, soybeans, squash, cucumbers, lettuce, potatoes and onions. Grains include, but are not limited to, oats, rice, wheat and barley. Fruits include, but are not limited to, apples, pears, peaches and kiwi.

Normally, a plurality of crops is treated by thermal fogging. Accordingly, when the specification uses the singular form describing a treated crop, such as a “plant,” a “vegetable,” a “fruit,” etc, the plural forms of these nouns are also intended to be covered.

The term “ethylene synthesis inhibitor” as used herein refers to a substance that inhibits or regulates the production of ethylene in plants, including post-harvest. In particular, the term “ethylene synthesis inhibitor” includes, but is not limited to, aminoethoxyvinylglycine (AVG), aminooxyacetic acid (AOA), rhizobitoxine, methoxyvinyl glycine (MVG), and salts thereof.

In a preferred embodiment, the ethylene synthesis inhibitor is aminoethoxyvinylglycine (AVG) or aminoethoxyvinylglycine HCl (AVG HCl).

The term “thermal fogging” (or thermofogging) refers to any technique by which active agents are applied to crops by entraining the active agent in a flow of heated air at controlled temperatures, concentrations, and velocities to produce a mist. While various forms of thermal fogging techniques are known (for example, U.S. Pat. No. 6,723,364 describes some of these techniques), this invention relates to surprisingly more effective techniques. The preferred thermofogging technique uses an “electric thermofogger” (or thermal logger) instead of a “combustion thermofogger”. The combustion thermofogger uses hot combustion exhaust gas for atomization of the liquid active agent into fine mists while an electric thermofogger uses an electric heater to heat the air for atomization. The electric thermofogger has the advantage of not introducing the potentially undesirable combustion exhaust gases, such as carbon dioxide, ethylene and water, into the system. Also, the electric thermofogger usually has better control of the atomization air temperature.

While the use of conventional thermal fogging techniques for application of ethylene synthesis inhibitors results in an inconsistent reduction of an internal ethylene production and no effect on fruit firmness or other quality parameters, the techniques according to the present invention are effective and significantly improve the efficiency of the methods and consistency of fruit response to thermal fogging treatment with AVG HCl.

In particular, in a preferred embodiment, the methods of the present invention allow one to achieve residues of at least about 800 parts per billion (ppb) AVG HCl on the crops in a treatment chamber or storage room as measured immediately after application. Generally, the higher the amount of the residues, more effective the methods are.

The thermal fogging device generally comprises a heating element, a blowing (also known as “air acceleration”) unit, an injection unit (generally comprising a liquid pump and an injector) and an atomization/gas mixing unit. The thermal fogging device may comprise other elements without departing from the invention. Further, a skilled artisan would be able to modify the thermal fogging device, as long as the modified thermal fogging device functions in accordance with the methods of the present invention.

In accordance with the invention, the thermal fogging device produces a fine thermal fogging mist from the compositions containing an ethylene synthesis inhibitor. This fine thermal fogging mist consists of droplets that contain particles of the ethylene synthesis inhibitor. In a preferred embodiment, about 90% of the particles are between about 0.1 micron and about 1 micron.

The thermal fogging mist is produced by injecting the liquid treating composition into hot air projected at high velocity into the atomization/gas mixing unit.

In a preferred embodiment, the temperature of the projected hot air is controlled to a reproducible, stable, narrow range between about 180° C. and about 500° C.; most preferably about 300° C.

In another preferred embodiment, the velocity of the projected hot air is between about 50 m/s and about 300 m/s; most preferably about 250 m/s.

The hot air velocity is proportional to a frequency transformer on the blower unit.

Thus, the invention provides a thin and homogeneous coating for the treated crops. The efficiency of the methods of the present invention depends on the quality of atomization in the thermal fogging device. Generally, a high air-to-liquid ratio and a higher exit temperature are preferred. At the same tine, thermal stability of the compositions containing an ethylene synthesis inhibitor is a critical limiting factor.

The term “exit temperature” as used herein refers to the temperature of the thermal fogging mist produced at the outlet of the thermal fogging device. When the liquid composition is injected into the hot air jet the temperature drops. Because of the drop in temperature, the production of a thermal fogging mist becomes possible, with a preferred exit temperature from the thermal fogging device of between about 100° C. and about 175° C.; most preferably about 130-150° C. The preferred exit temperature varies with the specific formulation used.

According to a preferred embodiment, the diameter of the cylindrical channel into which the hot air is projected is between about 12 mm and about 25 mm, preferably from about 16 mm to about 20 mm, and most preferably about 18 mm.

In a preferred embodiment, the heating of the liquid composition is performed for not more than about 20 milliseconds.

In the most preferred embodiment, the invention relates to a method of applying a composition containing an ethylene synthesis inhibitor to crops by thermal fogging, wherein said method comprises the steps of producing a thermal fogging mist from said composition, wherein said thermal fogging mist comprises particles of the ethylene synthesis inhibitor; applying an effective amount of said thermal fogging mist to said crops, wherein the thermal fogging mist is produced by injecting said composition into a thermal fogging device and projecting hot air into the device, wherein said hot air has a temperature of about 300° C. and a velocity of about 250 m/s, and wherein the exit temperature of said particles from the thermal fogging device is about 130-150° C.

In another embodiment, the invention also relates to the application of compositions containing an ethylene synthesis inhibitor which are suitable for post harvest application to crops by thermal fogging.

Preferred liquid compositions for application with the methods and equipment of the present invention comprise between about 0.1 weight % to about 50 weight % of an ethylene synthesis inhibitor, preferably from about 0.5 weight % to about 10 weight % of an ethylene synthesis inhibitor, and most preferably from about 1.0 weight % to about 5% of an ethylene synthesis inhibitor.

The liquid compositions for application with the methods and equipment of the present invention further comprise a solvent or a mixture of solvents. Preferred solvents include but are not limited to polyols. The solvent(s) can be either organic or inorganic. Boiling points of the solvents are preferably between about 70° C. and about 230° C.

Preferably, the solvent is a low molecular weight diol; most preferably, the solvent is propylene glycol.

Preferred liquid compositions of the present invention comprise between about 10.0 weight % to about 90 weight % of the solvent.

The liquid compositions also comprise water, preferably between about 0.1 weight % and about 15.0 weight %, more preferably between about 1.0 weight % and about 5.0 weight %.

The liquid composition may further comprise an adjuvant selected from the group consisting of an alcohol, ether, ester and dialkylamide, as for example, butyl acetate, dimethyl isosorbide, n-butyl lactate or N,N-dimethyl octanonate/decanoate amide. Most preferably, the adjuvant is dimethyl isosorbide. The adjuvant may be helpful to reduce the viscosity and surface tension of the solution.

Preferred liquid compositions for application with the equipment and methods of the present invention comprise between about 5.0 weight % to about 90 weight % of the adjuvant.

The liquid composition may comprise another active(s) in addition to an ethylene synthesis inhibitor. For example, the composition may also comprise an antioxidant, a sprouting inhibitor, another plant growth regulator, and/or a fungicide.

In addition, a surfactant may be added to the liquid composition. Preferably, the surfactant is a non-ionic surfactant that is present in an amount between about 0.1 weight % and about 2.0 weight % of the total composition. Preferably, the surfactant is an organosilicone surfactant.

In the most preferred embodiment, the liquid composition for the treatment of crops comprises from about 1.0% to about 5.0% by weight aminoethoxyvinylglycine hydrochloride; from about 10.0% to about 90.0% by weight propylene glycol; from about 1.0% to about 5.0% by weight water; from 0.0% to about 5.0% by weight ethanol: from about 1.0% to about 50.0% by weight dimethyl isosorbide; and from about 0.5% to about 1.0 % by weight of an organosilicone surfactant, wherein said composition is suitable for application to said crops by thermal fogging.

With respect to all mentioned concentrations, temperatures, velocities, times and other values, a person of ordinary skill in the art may vary and/or fine-tune the parameters depending on a particular plant and a particular effect desired.

According to the invention, the thermal fogging composition is applied post-harvest.

In one embodiment, the liquid composition for post-harvest treatment is applied within about 7 days post-harvest. In another embodiment, the liquid composition for post-harvest treatment is applied during post-harvest storage. In yet another embodiment, the liquid composition for post-harvest treatment is immediately before or just after the completion of post-harvest storage.

The liquid composition may be applied more than once; the frequency with which the applications are made depends on the crop and the desired effect.

In one embodiment, the crop is a fruit. In a preferred embodiment, the fruit is an apple.

In another embodiment, the crop is a vegetable.

The phrase “effective amount” of a thermal fogging mist means a sufficient amount of the thermal fogging mist to provide the desired effect without at the same time causing additional toxic effects. The amount of the mist that is “effective” will vary depending on a plant, the desired effect, and the like. Thus, it is not always possible to specify an exact “effective amount.” However, an appropriate “effective amount” in any individual case may be determined by one of ordinary skill in the art using routine experimentation.

Preferred methods of thermal fogging are methods that provide an effective amount of an ethylene synthesis inhibitor to obtain consistent improvements in delaying crop ripening or senescence after harvest.

Preferred methods of thermal fogging are methods that provide an effective amount of an ethylene synthesis inhibitor to obtain acceleration of sprouting of vegetables including potatoes or onions.

As used herein, all numerical values relating to amounts, weight percentages and the like, are defined as “about” or “approximately” each particular value, namely, plus or minus 10%. For example, the phrase “at least 5% by weight” is to be understood as “at least 4.5% to 5.5% by weight.” Therefore, amounts within 10% of the claimed values are encompassed by the scope of the claims.

The following examples are intended to illustrate the present invention and to teach one of ordinary skill in the art how to make and use the invention. They are not intended to limit the invention or its protection in any way.

### EXAMPLES

### Example 1

### Projected Hot Air Velocity

As Table 1 demonstrates, the higher velocity of the projected hot air affects the efficiency of thermal fogging methods of the present invention. The air velocity is proportional to the installed frequency transformer on the blower unit. The temperature of the projected hot air is the same in all three frequencies.

TABLE 1
Effect of air velocity on the quality of application

| Frequency (Hz) | Efficiency (%) | Residue distribution (T/B)* |
|---|---|---|
| 60 | 19.99 | 5.78 |
| 50 | 14.55 | 5.95 |
| 40 | 17.09 | 10.20 |

*T/B: Ratio Top/Bottom of the fruit stack (5 boxes high × 6 boxes per layer = 30 boxes = 0.7 ton fruit).

### Example 2

An Effect of the difference between the Hot Air Temperature and the Exit Temperature

As Table 2 demonstrates, the difference between the projected hot air temperature and the exit temperature of the droplets (ΔT) has a great effect on the efficiency of the methods of the present invention.

TABLE 2
Effect of air and product temperature difference
on the application quality.

| Air Temperature | Product (Fog) | | Efficiency | Distribution |
|---|---|---|---|---|
| ° C. | Temperature ° C. | ΔT | (%) | T/B |
| 200-210 | 140-150 | 50-70 | 14-17 | 5.5-7.0 |
| 245-255 | 140-150 | 95-115 | 7.3-8.3 | 3.6-4.2 |

### Efficacy Trials

Efficacy trials were conducted in apple cultivars Gala, Red Delicious and Pink Lady™ from July 2007 to December 2007. Apples were placed in plastic boxes along with 3-inch plastic balls to fill the maximum volume of the box. The thermal fogging was conducted in a small chamber containing a stack of 30 boxes (3×2×5 boxes). The stack filled approximately 60% of the volume of the chamber. In all trials, apples were sampled from the top, middle, and bottom of the stack. Each level was represented by 6 boxes. The evaluations in each trial consisted of fruit quality parameters (internal ethylene concentration (IEC), firmness (Lb), background color (BC), starch index (SI) and AVG residues on fruit models (plastic spheres) after application.

In general, AVG-HCl thermal fogging was consistently effective in reducing internal ethylene production in apples. Residues higher than approximately 800 parts per billion (ppb) were achieved after application. The dose applied to obtain this level of residues varied depending on fogging parameters used. Effective dosages also increased fruit firmness most of the time, when measured 4 to 10 days after application.

Initial fruit maturity prior to each AVG thermofogging treatment (shown in examples), varied from pre-climacteric fruit to advanced ripening fruit. The first stage was recognized by internal ethylene below 0.1 ppm, usually very firm fruit (above 18 lb/in² pressure, but cultivar-dependent), and less than 5 percent of starch degraded. From this point on the ripening process on fruit accelerates leading to increasingly internal ethylene concentration, decrease on fruit firmness, and increase on starch degradation, among others.

In summary, effectiveness of AVG thermofogging treatments was observed in fruit with various stages of ripening at the moment of the treatment.

### Example 3

### Efficacy Trials on Apple Cultivar Gala

Three experiments were run investigating the internal ethylene concentration (IEC) values in apples stored at 20° C. for 1 and 7 days after thermal fogging application with the methods and compositions of the present invention. The results are summarized in Tables 3 through 5.

TABLE 3
Model Residues (ppb): top (1127.9), Middle (227.2), Bottom (61.7)

| | |
|---|---|
| IEC, parts per | |
| million (ppm) | Firmness |

| Treatment | 1 day | 7 days | lb/in² |
|---|---|---|---|
| Control | 0.00 | 76.52 a | 15.7 |
| TOP | 0.06 | 43.88 b | 16.5 |
| MIDDLE | 0.06 | 71.27 a | 16.6 |
| BOTTOM | 0.32 | 71.47 a | 15.7 |
| P value | n.s.* | 0.045* | 0.060 |

*n.s = not statistically significant

TABLE 4
Model Residues (ppb): top (815.6), Middle (453.1), Bottom (83.9)

| | |
|---|---|
| IEC (ppm) | Firmness |

| Treatment | 1 day | 7 days | lb/in² |
|---|---|---|---|
| Control | 0.00 | 56.56 | 16.4 a |
| TOP | 0.03 | 37.01 | 17.3 b |
| MIDDLE | 0.15 | 65.53 | 15.8 a |
| BOTTOM | 0.27 | 77.29 | 16.4 a |
| P value | n.s. | n.s. | 0.045 |

TABLE 5
Model Residues (ppb): top (815.6), Middle (453.1), Bottom (83.9)

| | |
|---|---|
| IEC (ppm) | Firmness |

| Treatment | 1 day | 7 days | lb/in² |
|---|---|---|---|
| Control | 2.73 | 58.50 a | 16.3 |
| TOP | 0.49 | 16.26 b | 15.5 |
| MIDDLE | 1.42 | 88.70 a | 16.1 |
| BOTTOM | 5.67 | 87.63 a | 16.6 |
| P value | n.s. | 0.000 | n.s. |

### Example 4

Treatment Effect after Storage of Apples at Low Temperature

The IEC values in apples stored at low temperatures prior to thermal fogging with the methods and compositions of the present invention were measured. The results are summarized in Tables 6 through 9.

The results obtained when apple cultivar Gala was stored for 4 and 8 days at cold storage (0-2° C.) and then stored at 20° C. for 8 days are summarized in Tables 6 and 7.

TABLE 6
Model Residues (ppb): top (2394.2), Middle (746.4), Bottom (481.7)

| | |
|---|---|
| IEC (ppm) | Firmness (lb/in²) |

| Treatment | 4 days | 8 days | 4 days | 8 days |
|---|---|---|---|---|
| Control | 34.57 b | 16.24 a | 14.6 a | 14.3 a |
| TOP | 5.81 a | 0.00 c | 17.6 c | 17.6 b |
| MIDDLE | 37.93 b | 3.12 bc | 16.4 b | 17.5 b |
| BOTTOM | 68.24 c | 9.09 ab | 16.7 bc | 17.4 b |
| P value | <0.0001 | 0.0008 | <0.0001 | <0.0001 |

TABLE 7
Model Residues (ppb): top (1759.2), Middle (488.4), Bottom (159.5)

| | |
|---|---|
| IEC (ppm) | Firmness (lb/in²) |

| Treatment | 4 days | 8 days | 4 days | 8 days |
|---|---|---|---|---|
| Control | 55.92 a | 63.75 a | 11.7 a | 12.2 a |
| TOP | 0.06 c | 0.00 c | 13.4 b | 14.0 c |
| MIDDLE | 5.21 b | 6.10 b | 14.0 b | 13.3 b |
| BOTTOM | 2.97 c | 39.46 a | 13.4 b | 12.8 ab |
| P value | <0.0001 | <0.0001 | <0.0001 | 0.0005 |

The results obtained when apple cultivar Red Delicious was stored at 20° C. for 5 and 10 days and then stored for 1 month at cold storage (0-2° C.) are summarized in Table 8.

TABLE 8
Model Residues (ppb): top (3954), Middle (999.6), Bottom (522.6)

| | |
|---|---|
| IEC (ppm) | Firmness (lb/in²) |

| Treatment | 5 days | 10 days | 5 days | 10 days |
|---|---|---|---|---|
| Control | 35.0 a | 47.6 a | 10.3 a | 11.6 a |
| TOP | 0.02 b | 0.00 b | 14.6 b | 14.9 b |
| MIDDLE | 0.61 b | 0.04 b | 14.4 b | 15.4 b |
| BOTTOM | 8.05 c | 10.6 c | 10.4 a | 11.4 a |
| P value | <0.0001 | <0.0001 | <0.0001 | <0.0001 |

The results obtained when apple cultivar Pink Lady™ was stored at 20° C. for 5 and 10 days and then stored for 15 days at cold storage (0-2° C.) are summarized in Table 9.

TABLE 9
Model Residues (ppb): top (7022), Middle (1675), Bottom (645)

| | |
|---|---|
| IEC (ppm) | Firmness (lb/in²) |

| Treatment | 5 days | 10 days | 5 days | 10 days |
|---|---|---|---|---|
| Control | 3.02 a | 6.58 a | 19.4 a | 16.9 a |
| TOP | 0.00 b | 0.00 b | 21.4 b | 21.5 b |
| MIDDLE | 0.21 b | 0.09 b | 21.3 b | 20.1 c |
| BOTTOM | 2.14 a | 0.07 b | 20.1 a | 18.9 d |
| P value | <0.0001 | 0.015 | <0.0001 | <0.0001 |

### Example 5

Treatment effect after extended storage of apples at low temperature followed by a 7 day period at room temperature, with single and repeated thermal fogging applications of AVG HCl.

This experiment was run to determine the effects of thermofogging of AVG HCl on the synthesis of ethylene in the fruit, and on the maintenance of fruit flesh firmness after extended cold storage followed by seven days at room temperature. Apples (cv. Gala) were harvested at the normal commercial harvest time in the State of Washington in the fall of 2008. Twenty four hours after harvest (zero day), fruits were thermal fogged with AVG HCl to reach the target level of AVG peel residues of either 1 ppm or 5 ppm. Fruits were also left untreated as a control. Immediately after thermal fogging, all fruits were stored at 0-1° C. in regular commercial cold storage for periods of 30, 60 and 120 days. Additionally, after 30 and 60 days of storage, subsets of fruits that had initially been thermal fogged at 1 ppm and 5 ppm at harvest time received another thermal fogging treatment, each at the same residue target level. These treatments are labeled in Tables 10 and 11 as 1-1 ppm and 5-5 ppm to indicate the repeated treatment at 30 days, and as 1-1-1 ppm and 5-5-5 ppm to indicate the repeated treatments at 30 and 60 days. Following the different storage periods, fruits were placed in a room at 20° C. for seven days. At the end of the seven day period, fruit internal ethylene concentration (IEC) was recorded by drawing a sample of air from the core space of the fruit with a needle and analyzing for ethylene by gas chromatography (GC). Flesh firmness was also recorded using an automated modification of the Magness-Taylor pressure tester with a 7/16″ tip.

TABLE 10
Internal ethylene concentration^{(z)} (IEC, ppm) of Gala apples thermal
fogged with 2 target levels of AVG once, twice and three times,
and kept for several cold storage periods
followed by 7 days at room temperature.

| | | | 120 days cold |
|---|---|---|---|
| | 30 days cold | 60 days cold | storage + |
| Treatment: | storage + 7 | storage + | 7 days at |
| Target level of AVG | days at room | 7 days at room | room |
| on the fruit surface | temperature | temperature | temperature |
| Untreated control: 0 ppm | 151.8 | 171.2 | 392.2 |
| 1 ppm at 0 day | 1.7 | 1.3 | 37.9 |
| 5 ppm at 0 day | 0.0 | 0.0 | 1.5 |
| 1 + 1 ppm at 0 and 30 | — | 1.9 | 12.2 |
| days | | | |
| 5 + 5 ppm at 0 and 30 | — | 0.0 | 0.5 |
| days | | | |
| 1 + 1 + 1 ppm at 0, 30 | — | — | 2.7 |
| and 60 days | | | |
| 5 + 5 + 5 ppm at 0, | — | — | 0.1 |
| 30 and 60 days | | | |

^{(z)}Average initial IEC measured at harvest time in a representative number of fruits was 0.0 ppm.

Single or multiple applications of AVG HCl by thermal fogging effectively inhibited ethylene synthesis in fruits through 120 days of cold storage followed by 7 days at room temperature (Table 10). Repeated applications further extended the ethylene inhibition period.

TABLE 11
Fruit flesh firmness^{(z)} (Lbs.) Gala apples thermal fogged with 2 target
levels of AVG once, twice and three times, and kept for several cold
storage periods followed by 7 days at room temperature.

| | 30 days cold | 60 days cold | 120 days cold |
|---|---|---|---|
| Treatment: | storage + 7 | storage + | storage + |
| Target level of AVG | days at room | 7 days at room | 7 days at room |
| on the fruit surface | temperature | temperature | temperature |
| Untreated control: 0 ppm | 16.1 | 15.2 | 14.0 |
| 1 ppm at 0 day | 17.4 | 16.6 | 14.9 |
| 5 ppm at 0 day | 17.4 | 16.5 | 15.1 |
| 1 + 1 ppm at 0 and 30 | — | 16.7 | 15.4 |
| days | | | |
| 5 + 5 ppm at 0 and 30 | — | 16.6 | 15.4 |
| days | | | |
| 1 + 1 + 1 ppm at 0, 30 | — | — | 15.2 |
| and 60 days | | | |
| 5 + 5 + 5 ppm at 0, | — | — | 15.6 |
| 30 and 60 days | | | |

^{(z)}Average initial fruit flesh firmness measured at harvest time in a representative number of fruits was 18.4 lbs.

Single or multiple applications of AVG by thermal fogging effectively delayed the softening process in the fruit flesh (Table 11). Repeated applications tended to delay fruit softening.

Taken together, these results show that thermal fog application of AVG to apples during postharvest storage can effectively inhibit ethylene and fruit softening and consequently extend cold storage quality.

1. A method of applying a composition containing an ethylene synthesis inhibitor to crops by thermal fogging comprising the steps of producing a thermal fogging mist from said composition, wherein said thermal fogging mist contains particles of the ethylene synthesis inhibitor and applying an effective amount of said thermal fogging mist to said crops.

2. The method of claim 1, wherein said ethylene synthesis inhibitor is aminoethoxyvinylglycine or a salt thereof.

3. The method of claim 2, wherein said ethylene synthesis inhibitor is aminoethoxyvinylglycine hydrochloride.

4. The method of claim 1, wherein the thermal fogging mist is produced by injecting said composition inside a thermal fogging device and projecting hot air into the device, wherein said hot air has a stable temperature between about 180° C. and about 500° C.

5. The method of claim 4, wherein said temperature is about 300° C.

6. The method of claim 1, wherein the exit temperature of said particles from the thermal fogging device is between about 100° C. and about 175° C.

7. The method of claim 6, wherein said exit temperature is about 130-150° C.

8. The method of claim 4, wherein the velocity of said hot air is between about 50 m/s and about 300 m/s.

9. The method of claim 8, wherein said velocity is about 250 m/s.

10. A method of applying a composition containing an ethylene synthesis inhibitor to crops by thermal fogging, wherein said method comprises:
producing a thermal fogging mist from said composition, wherein said thermal fogging mist contains particles of the ethylene synthesis inhibitor; and
applying an effective amount of said thermal fogging mist to said crops, wherein the thermal fogging mist is produced by injecting said composition into a thermal fogging device and projecting hot air into the device, wherein said hot air has a stable temperature of about 300° C. and a velocity of about 250 m/s, and wherein the exit temperature of said particles from said thermal fogging device is about 130-150° C.
